(19) United States
(12) Patent Application Publication
(10) Pub. No.: US 2015/0158307 A1
(43) Pub. Date: Jun. 11, 2015

(54) Hybrid Communication Module

(71) Applicants: Francois Lechleiter, Favrieux (FR); Corinne Guesdon, Sorel-Moussel (FR); Laurent Berdalle, Saint-Aquilin-De-Pacy (FR)

(72) Inventors: Francois Lechleiter, Favrieux (FR); Corinne Guesdon, Sorel-Moussel (FR); Laurent Berdalle, Saint-Aquilin-De-Pacy (FR)

(73) Assignee: Linxens Holding, Guyancourt (FR)

(21) Appl. No.: 14/241,963

(22) PCT Filed: Sep. 1, 2011
(86) PCT No.: PCT/IB2011/002428

§ 371 Date: Jun. 19, 2014

(51) Int. Cl. B41J 2/175; H04W 4/00

(52) U.S. Cl. CPC B41J 2/17546; H04W 4/008

(57) ABSTRACT

Equipment system including a first and a second series of pieces of equipment, each of the pieces of equipment belonging to either the first or the second series, and being adapted to receive a communicating consumable device and including communication means with said consumable device, the communication means of the pieces of equipment of the first series including electrical contact fingers, the communication means of the pieces of equipment of the second series being of a contactless type. It further includes a plurality of identical consumable devices including each an hybrid communication module including both electrical pads configured and arranged to be connected by the contact fingers of a piece of equipment of the first series, as well as an antenna circuit adapted for contactless communication with a piece of equipment of the second series.

### FIELD OF THE INVENTION

The invention relates to communication modules, in particular for those inserted in a consumable device, to exchange communication data with a piece of equipment which receives that consumable device. For example, the communication module may be used in an ink cartridge received in a printer.

Traditional communication modules are inserted in ink cartridge. They include electric contact pads. The printer comprises flexible contact fingers which are bent during the insertion of the ink cartridge in the printer. The exchanged data could be the date of the first use and/or the ink level in the cartridge or the like. The printer reads this information and can send a warning message to the user. A drawback of such a communication module is that the contact fingers are fragile and can be damaged by a wrong insertion operation of a cartridge. Another drawback is that the relative position of the cartridge within the printer must be precisely controlled and guaranteed.

In such a field, an economical constraint affects any change of consumables technology due to the very large number of consumable item spread out in wholesaler stocks, in retailer stocks, in firm stocks, in stationary stocks and in any of household stocks. A technical constraint against changing the technology of consumable comes from the need to only propose new technology when the new consumable device is smaller than the old one in order to limit the changes inside the piece of equipment in which such a consumable device is implemented.

The invention provides a communication module, as well as an ink cartridge and an equipment system using consumable devices including such a communication module which remedy to at least one of the above drawbacks, taking into account the above constraints.

The aim of the invention is to provide a more flexible communication module to be inserted in consumable devices compatible with a wider range of piece of equipment receiving these communicating consumable devices.

### SUMMARY OF THE INVENTION

According to one embodiment, the invention provides an equipment system comprising a first and a second series of pieces of equipment. Each of the pieces of equipment belonging to either the first or the second series are adapted to receive a communicating consumable device and comprise communication means with said consumable device. The communication means of the pieces of equipment of the first series comprise electrical contact fingers. The communication means of the pieces of equipment of the second series are of a contactless type. The system further comprises a plurality of identical consumable devices including each an hybrid communication module comprising both electrical pads configured and arranged to be connected by the contact fingers of a piece of equipment of the first series, as well as an antenna circuit adapted for contactless communication with a piece of equipment of the second series.

In such system, the user of a traditional piece of equipment belonging to the first series can continue to use his proper stock of traditional consumables only having electrical pads. Later, he could resupply consumables according to the system without any breaking off of services. Then, he can buy a piece of equipment according to the second series of the system and can still use the same consumable devices of the system for both pieces of equipment. Therefore, the traditional consumable devices can be discontinued and replaced by the above system without any services breaking off.

According to another aspect, the invention provides a communication module for a consumable device to be received in a piece of equipment, like a printer ink cartridge, comprising:

a flex circuit including a series of electrical pads extending on a first face of the flex circuit, the electrical pads being configured and arranged to be connected by contact fingers of the piece of equipment, and

an electronic chip connected to these electrical pads,

an antenna circuit extending on a second face of the flex circuit opposite the first face, and located at least in front of the electrical pads, the electronic chip being connected to the antenna circuit and adapted for contactless communication with said piece of equipment.

The antenna circuit provides the ability for contactless communication. The particular location of the antenna in front of the electrical pads allows for the communication module of the invention to keep the same size or similar than the traditional communication modules only having chip with electrical pads. So, the communication module of the invention provides extra communication ability within a similar space.

In some other embodiments, one might also use one or more of the feature as defined in dependent claims.

### BRIEF DESCRIPTION OF THE DRAWINGS

Other characteristics and advantages of the invention will readily appear from the following description of some of its embodiments, provided as a non-limitative example, and of the accompanying drawings.

On the drawings:

FIG. 1 is a top view of a first embodiment of the communication module,

FIG. 2 is a cross-section of the first embodiment, according to the plan II-II of FIG. 1,

FIG. 3 is a cross-section of a second embodiment,

FIG. 4 is a cross-section of a third embodiment, and

FIGS. 5A and 5B illustrate an equipment system.

### DETAILED DESCRIPTION

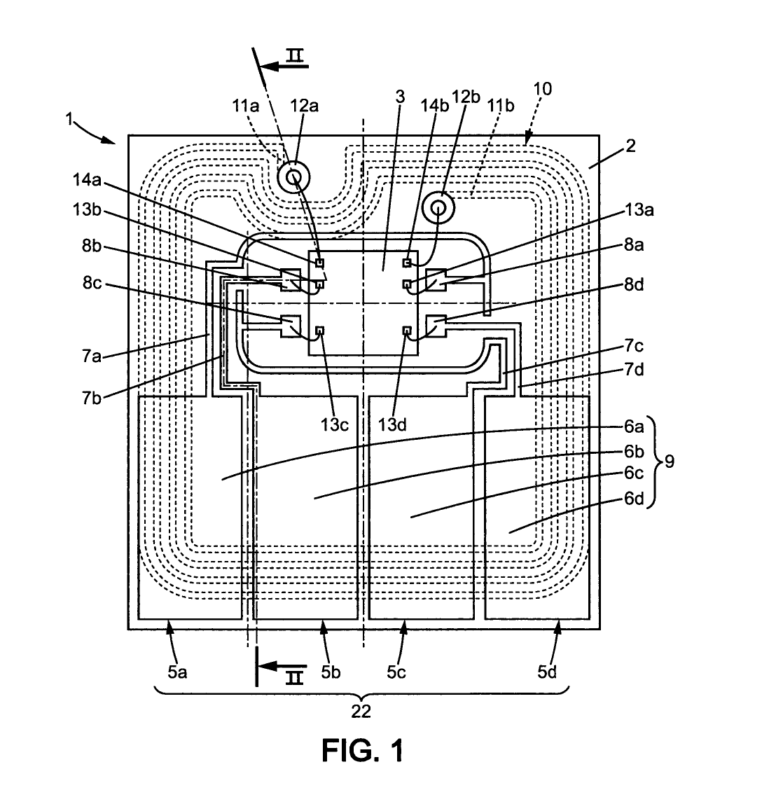

As illustrated in FIG. 1, the communication module 1 comprises a flex circuit 2 and an electronic chip 3. The flex circuit 2 consists in a flexible electrically isolating sheet 4 made of synthetic material. A metallic layer 22 is laid down, on both sides of the flexible sheet 4 and extends only on predetermined zones in order to form electrical circuits independent from each other. On a first face 18 of the flex circuit 2 which is visible on FIG. 1, the flex circuit 2 comprises four independent electrical circuits 5a,5b,5c, 5d. Each electrical circuit includes an electrical pad 6a,6b,6c, 6d, an electrical thin wire 7a,7b,7c,7c, and an electrical terminal 8a,8b,8c,8d. The electrical pads 6a,6b,6c,6d, having each a rectangular shape, are aligned side by side with each other along a pad segment 9. All the electrical terminals 8a, 8b, 8c are located close to the electronic chip 3. The first face 18 is also called the front face 18.

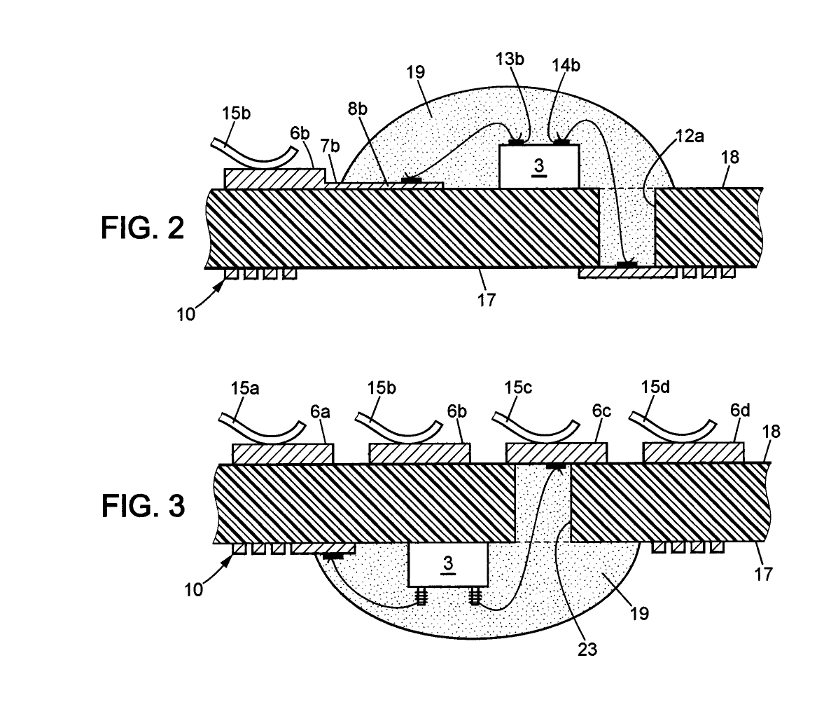

An antenna circuit 10 extends on a second face 17, or rear face 17, which is opposite to the front face 18 of the flex circuit 2. The antenna circuit 10 is illustrated in doted line in FIG. 1. The antenna circuit 10 is also made of a metallic deposit layer etched to form a unique metallic conductor 10. The metallic conductor 10 forming the antenna circuit 10 has a spiral shape and comprises four concatained and concentric loops having each a substantial square shape. Two extremities 11a,11b of said unique conductor 10 are connected to a corresponding blind through hole 12a,12b crossing through the thickness of the flex circuit 2 (see FIG. 2).

The electronic chip 3 comprises four electric terminals 13a,13b,13c,13d dedicated to contact communication, and two electrical terminals 14a, 14b dedicated to contactless communication. A wire bonding connects each of the electrical terminals 13a,13b,13c,13d to the corresponding terminals 8a,8b,8c,8d of the electrical circuit 5a,5b,5c,5d. The two electrical terminals 14a,14b are also connected by wire bonding to blind through holes 12a,12b.

The electronic chip 3 is a dual electronic chip designed to provide the same communication either through the four electrical terminals 13a,13b,13c,13d, or through the two electrical terminals 14a,14b. In particular, the antenna circuit 10 is used for receiving energy and to emit response signal. When the electronic chip 3 is using the electrical pads 6a,6b,6d, two of them may be used for inputs and two other may be used for outputs.

The width of the antenna circuit 10 is equal to the length of the pad segment 9. Therefore, the area of the rear face of the flex circuit 2 used for the antenna circuit 10 is minimum and corresponds to the width used for the electrical pads 6a,6b,6c,6d.

The antenna circuit 10 comprises a local U-shape surrounding the blind through hole 12a connected to the extremity 11a of the external loop. The blind through hole 12b is located between the electrical wire 7a and the inside of the internal loop. Therefore, the shape of the antenna circuit 10 is a compromise of a maximisation of the inside area of the loops of the antenna circuit 10 and a minimisation of the surface of the flex circuit 2. In other words, the antenna circuit 10 surround an area of the rear face 17 corresponding to the minimum surface requested on the front face of the flex circuit 2 to implement the four electrical pads 6a,6b,6c,6d, the electronic chip 3 and the two through holes 12a,12b.

As illustrated in FIG. 2, the blind through hole 12a is only metallised at the rear face 17 on which extends the antenna circuit 10. Therefore, the wire bonding has to reach the metallic layer extending at the bottom at the through hole 12a. A potting resin 19, for example an epoxy type resin, surrounds all the wire bondings, all the electrical terminals 8a,8b,8c,8d, the whole electronic chip 3 and the two blind through holes 12a,12b. The potting resin 19 does not cover the electrical pads 6a,6b,6c,6d. A flexible contact finger 15a,15b,15c,15d can connect the corresponding electrical pad 6a,6b,6c,6d.

The bottom face of the first embodiment is substantially flat, which allows an easy fixation, for example by gluing, on a flat surface of a consumable device.

As illustrated in FIG. 3, the electronic chip 3 of the second embodiment is implemented in the rear face 17 on which the antenna circuit 10 extends. A blind through hole 23 can be implemented under one of the electrical pads. That second embodiment has the advantage of having the front face 18 totally free from potting resin 19. This gives the opportunity to have larger electrical pads 6a,6b,6d and to reduce the tolerance requested for positioning the communication module and the consumable device inside the piece of equipment.

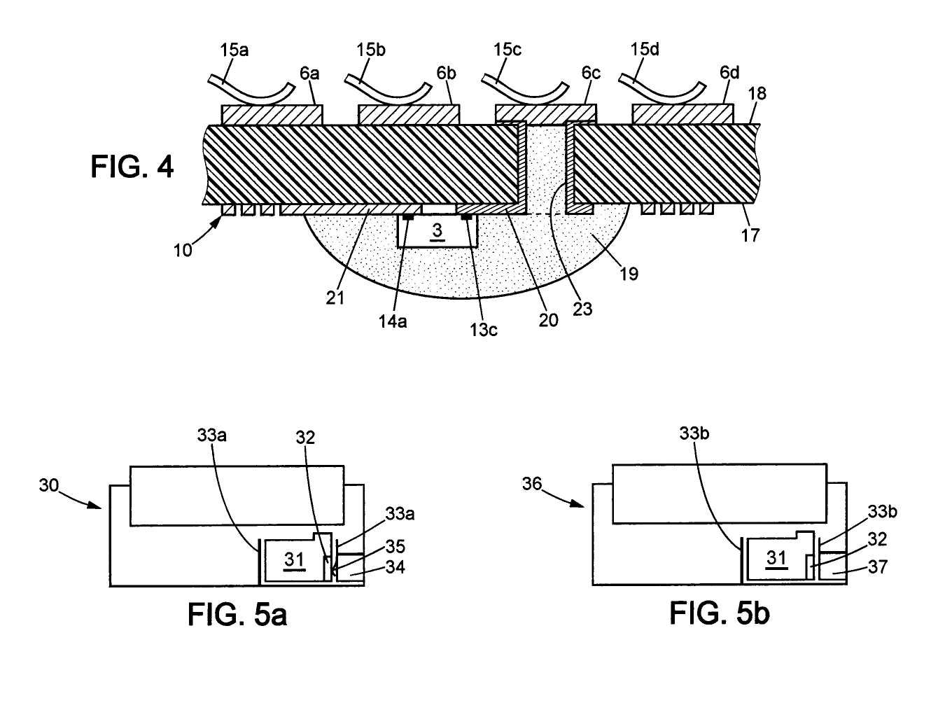

As illustrated in FIG. 4, the blind through hole 23 is now a metallised through hole. There is an electrical connection between an electrical pad 6c and a metallic layer 20 extending on the rear face 17 around the metalized through hole 23. The electronic chip 3 is connected to that metallic layer 20 by a flip chip technology. The electrical terminals 13a,13b,13c,13d, as well as the electrical terminal 14a,14b of the electronic chip 3 are directed to a bottom face of the chip 3 directly in contact with the metallic layer 20 connected with the through hole 23 or with an electrical terminal 21 connected with the antenna circuit 10.

As illustrated in FIG. 5a, 5b, an embodiment of the equipment system comprises a first series 30 of piece of equipment, like printers (FIG. 5a). Each piece of equipment of the first series 30 receives a communicating consumable device 31 which includes a communicating module 32. The communicating consumable device 31 could be an ink cartridge. The piece of equipment of the first series 30 comprises positioning means 33a and communication means 34 which include contact fingers 35.

The equipment system further comprises a second series 36 of piece of equipment (FIG. 5b), of a similar type, like printers. Each piece of equipment of the second series 36 receives a communicating consumable device 31 identical to the communicating consumable device received by each of the piece of equipment of the first series 30. Each piece of equipment of the second series 36 further comprises communicating means 37 of a contactless type and does not comprise contact fingers.

In other words, the compatibility of the pieces of equipment of the second series 36 with the communicating consumable device 31 received by the pieces of equipment of the first series 30 is only provided by the consumable device 31 itself and its communication module 32.

Each piece of equipment of the second series 36 comprises positioning means 33b identical to the positioning means 33a of the printer of the first series 30. Alternatively, the positioning means 33b may be different and compatible with the same consumable device 31.

1. Equipment system comprising a first and a second series of pieces of equipment, each of the pieces of equipment belonging to either the first or the second series, and being adapted to receive a communicating consumable device and comprising communication means with said consumable device, the communication means of the pieces of equipment of the first series comprising electrical contact fingers, the communication means of the pieces of equipment of the second series being of a contactless type, characterized in that it further comprises a plurality of identical consumable devices including each an hybrid communication module comprising both electrical pads configured and arranged to be connected by the contact fingers a piece of equipment of the first series, as well as an antenna circuit adapted for contactless communication with a piece of equipment of the second series.

2. Equipment system according to claim 1, wherein each of the communicating consumable devices further comprises identical positioning means structured and arranged to cooperate either with first complementary positioning means of a piece of equipment of the first series, or with second complementary positioning means of a piece of equipment of the second series.

3. Equipment system according to claim 1, wherein the communication modules comprise:
a flex circuit including a series of electrical pads extending on a first face of the flex circuit, the electrical pads being configured and arranged to be connected by contact fingers of the piece of equipment of the first series, and
an electronic chip connected to these electrical pads,
an antenna circuit located at least in front of the electrical pads, the electronic chip being connected to the antenna circuit and adapted for contactless communication with said piece of equipment of the second series.

4. Equipment system according to claim 3, wherein all the electrical pads of each communication module are aligned side by side along a pad segment, the antenna circuit being limited on its width inside an area facing the pad segment.

5. Equipment system according to claim 1, wherein the antenna circuit of each communication module has a substantially square shape.

6. Equipment system according to claim 1, wherein the electronic chip is fixed on the first face of the communication module and the antenna circuit extremities are connected to the electronic chip by wire bonding or by a metalized blind or through hole.

7. Equipment system according to claim 3, wherein the electrical chip of each communication module is fixed on the second face and the electrical pads are connected to the chip by wire bonding or by a metalized blind or through hole.

8. Equipment system according to claim 6, wherein the electronic chip of each communication module is connected to the circuit of the face where the chip stands by flip-chip or by wire bonding .

9. Equipment system according to claim 1, wherein the pieces of equipment are printers and the consumable devices are ink cartridges.

10. Ink cartridge for equipment system according to claim 1.

11. Ink cartridge according to claim 10, further comprising positioning means adapted to position the cartridge inside a printer.

12. Communication module for an equipment system according to claim 1.

13. Communication module for a consumable device to be received in a piece of equipment, like a printer ink cartridge, comprising:
a flex circuit including a series of electrical pads extending on a first face of the flex circuit, the electrical pads being configured and arranged to be connected by contact fingers of the piece of equipment, and
an electronic chip connected to these electrical pads, characterized in that it comprises an antenna circuit extending on a second face of the flex circuit opposite the first face, and located at least in front of the electrical pads, the electronic chip being connected to the antenna circuit and adapted for contactless communication with said piece of equipment.

14. Communication module according to claim 13, wherein all the electrical pads are aligned side by side along a pad segment, the antenna circuit being limited on its width inside an area facing the pad segment.

15. Communication module according to claim 13, wherein the antenna circuit has a substantially square shape.

16. Communication module according to claim 13, wherein the electronic chip is fixed on the first face and the antenna circuit extremities are connected to the electronic chip by wire bonding or by a metalized blind or through hole.

17. Communication module according to claim 13, wherein the electrical chip is fixed on the second face and the electrical pads are connected to the chip by wire bonding or by a metalized blind or through hole.

18. Communication module according to claim 16, wherein the electronic chip is connected to the circuit of the face where the chip stands by flip-chip or by wire bonding.
